(19) United States
(12) Patent Application Publication
(10) Pub. No.: US 2024/0351826 A1
(43) Pub. Date: Oct. 24, 2024

(54) RAISING AND LOWERING DEVICE

(71) Applicant: DAIFUKU CO., LTD., Osaka (JP)

(72) Inventor: Takumi SAKATA, Shiga (JP)

(73) Assignee: DAIFUKU CO., LTD., Osaka (JP)

(21) Appl. No.: 18/421,340

(22) Filed: Jan. 24, 2024

(30) Foreign Application Priority Data
Apr. 24, 2023 (JP) 2023-071030

(51) Int. Cl. B66B 9/00

(52) U.S. Cl. CPC B66B 9/00; B61B 3/00; B66F 11/04

(57) ABSTRACT

In order to easily install a platform, a raising and lowering device includes: a frame; a raising and lowering rail that a conveyance carriage is able to enter; a raising and lowering member configured to be raised and lowered integrally with the raising and lowering rail and to be, when located at a lowering stoppage position, supported by a support part provided to the frame; and a platform configured to be detachably placed on the raising and lowering member, the platform being configured to be placed on the raising and lowering member in a state in which a part of the platform is engaged with a part of the raising and lowering member in a manner so as to restrain the platform from moving in a horizontal direction.

This Nonprovisional application claims priority under 35 U.S.C. § 119 on Patent Application No. 2023-071030 filed in Japan on Apr. 24, 2023, the entire contents of which are hereby incorporated by reference.

### TECHNICAL FIELD

The present invention relates to a raising and lowering device that raises and lowers a carrier between rails arranged one above the other.

### BACKGROUND ART

In some cases, two rails each for a ceiling carrier are provided one above the other. In such a case, a carrier lifter is used in order to cause the ceiling carrier to move between the upper rail and the lower rail. The rails each for a ceiling carrier, even the lower rail, are provided in the vicinity of a ceiling. Thus, maintenance of the carrier lifter is performed at heights.

Patent Document 1 discloses a carriage raising and lowering device in which a maintenance step is placed so as to span across the support frames.

### CITATION LIST

### Patent Literature

[Patent Literature 1]

International Publication WO2022/215345

### SUMMARY OF INVENTION

### Technical Problem

However, the art disclosed in Patent Literature 1, regarding to installation of a maintenance step, has room for improvement for facilitating placement of the maintenance step while ensuring safety.

It is an object of an aspect of the present invention to achieve a raising and lowering device in which a platform can be easily installed.

### Solution to Problem

In order to the foregoing problem, a raising and lowering device in accordance with an aspect of the present invention includes: a frame; a rail that a ceiling traveling vehicle is able to enter and that is able to be raised and lowered; a raising and lowering part configured to be raised and lowered integrally with the rail and to be, when located at a lowering stoppage position, supported by a support part provided to the frame; and a platform configured to be detachably placed on the raising and lowering part. The platform is configured to be placed on the raising and lowering part in a state in which a part of the platform is engaged with a part of the raising and lowering part in a manner so as to restrain the platform from moving in a horizontal direction.

### Advantageous Effects of Invention

According to an aspect of the present invention, a platform is placed on a raising and lowering part. It is therefore possible to divide the platform into small segments and install the segments and thus to allow an operator with little strength to easily install the platform.

### BRIEF DESCRIPTION OF DRAWINGS

FIG. 1 is a front view illustrating a raising and lowering device in accordance with an embodiment of the present invention.

FIG. 2 is a perspective view illustrating a configuration of the raising and lowering device.

FIG. 3 is a view showing that an operator is on a platform installed on the raising and lowering device.

FIG. 4 is a view illustrating an example of a raising and lowering part of the raising and lowering device.

FIG. 5 is a view illustrating an example of the platform.

FIG. 6 is a view illustrating an example in which the platform is placed on the raising and lowering part.

FIG. 7 is a cross-sectional view taken along the A-A line illustrated in FIG. 6.

FIG. 8 is a view showing that a raising and lowering member is placed in a frame of the raising and lowering device.

FIG. 9 is a view illustrating another example of the platform.

FIG. 10 is a view illustrating a cross section of the platform placed on the raising and lowering member.

FIG. 11 is a view illustrating an example of a protruding part provided to the platform.

FIG. 12 is a view illustrating still another example of the platform.

### DESCRIPTION OF EMBODIMENTS

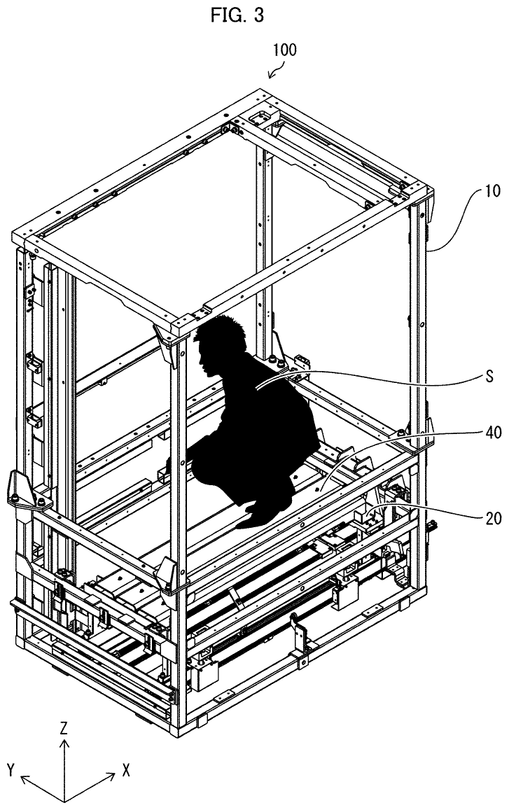

The following description will discuss an embodiment of the present invention in detail. A raising and lowering device 100 in accordance with the present embodiment is included in a conveyance carriage system 1 in order to raise and lower the conveyance carriage 120. The raising and lowering device 100 is provided, at an upper portion thereof, with members such as a driving part. Thus, operations such as maintenance are performed at heights. Accordingly, a platform is necessary which allows an operator S (see FIG. 3) to perform such operations. The raising and lowering device 100 is configured such that a platform 40 (see FIG. 3) serving as a platform on which the operator S performs the operations can be easily installed.

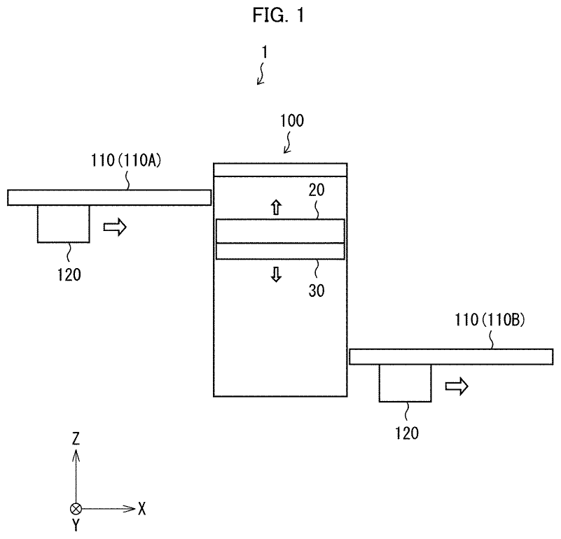

With reference to FIG. 1, the following description will discuss the conveyance carriage system 1 including the raising and lowering device 100. FIG. 1 is a front view illustrating an outline of the raising and lowering device 100. As illustrated in FIG. 1, the raising and lowering device 100 is used in the conveyance carriage system 1 that conveys an article P with use of a conveyance carriage (ceiling traveling vehicle) 120 along traveling rails 110 suspended from, for example, the ceiling. More specifically, in the conveyance carriage system 1, the two traveling rails 110 are provided one above the other. The raising and lowering device 100 is used to move the conveyance carriage 120 between the two traveling rails 110.

The raising and lowering device 100 lowers the conveyance carriage 120 that has been traveling along an upper traveling rail 110A, so as to allow the conveyance carriage 120 to travel along a lower traveling rail 110B. The raising and lowering device 100 also raises the conveyance carriage 120 that has been traveling along the lower traveling rail 110B, so as to allow the conveyance carriage 120 to travel along the upper traveling rail 110A.

That is, the conveyance carriage 120 that has been traveling along the traveling rail 110A enters a raising and lowering rail 30 in the raising and lowering device 100 and then a raising and lowering member (raising and lowering part) 20 integrated with the raising and lowering rail 30 is lowered. This allows the conveyance carriage 120 to move from the traveling rail 110A to the traveling rail 110B. In addition, the conveyance carriage 120 that has been traveling along the traveling rail 110B enters the raising and lowering rail 30 in the raising and lowering device 100 and then the raising and lowering member 20 integrated with the raising and lowering rail 30 is raised. This allows the conveyance carriage 120 to move from the traveling rail 110B to the traveling rail 110A. The raising and lowering rail 30 is a rail that is raised and lowered integrally with the raising and lowering member 20. In the present embodiment, an x direction is a direction along the raising and lowering rail 30, a y direction is a direction perpendicular to the raising and lowering rail 30, and a z direction is a vertical direction.

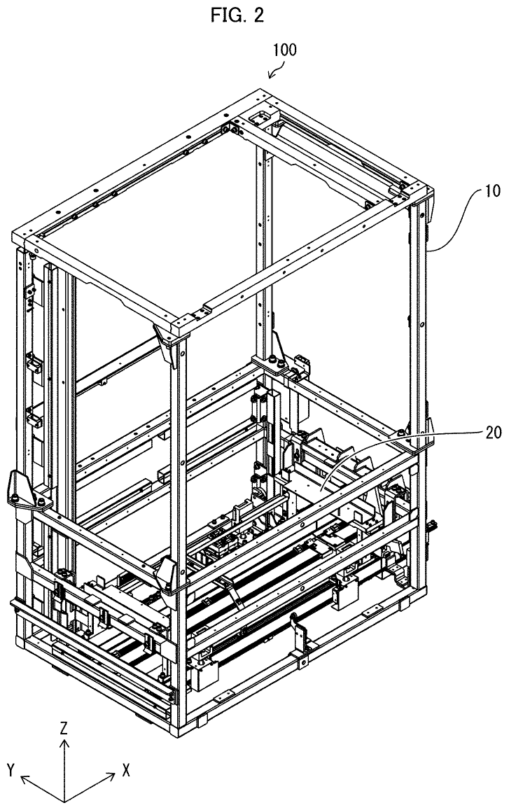

FIG. 2 illustrates a configuration of the raising and lowering device 100. FIG. 2 is a perspective view illustrating an outline of the configuration of the raising and lowering device 100. As illustrated in FIG. 2, the raising and lowering device 100, for example, raises and lowers the conveyance carriage 120 through raising and lowering of the raising and lowering member 20 integrated with the raising and lowering rail 30 in a space which is defined by a frame 10 to have a substantially cuboid shape.

FIG. 3 shows that an operator S is performing an operation on a platform 40 installed on the raising and lowering member 20. In the raising and lowering device 100 in accordance with the present embodiment, the raising and lowering member 20 is installed in the frame 10 of the raising and lowering device 100, and the platform 40 can be placed on the raising and lowering member 20. This configuration will be described later in detail. On the platform 40, the operator S can perform operations, such as maintenance of the raising and lowering device 100.

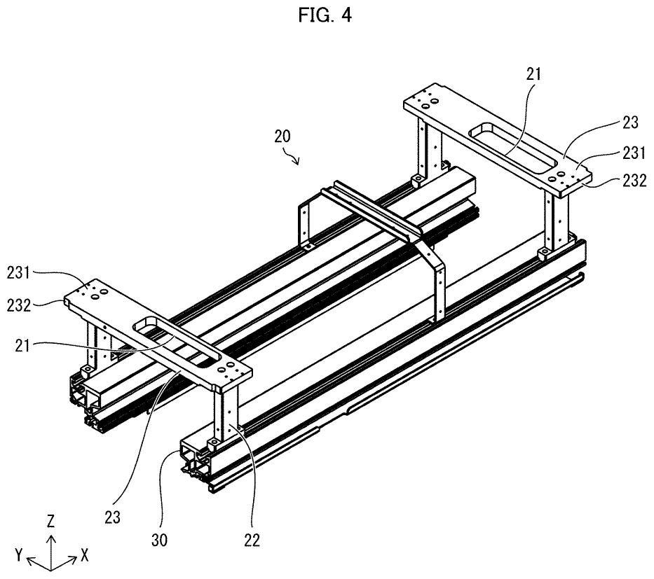

FIG. 4 illustrates an appearance of the raising and lowering member 20. FIG. 4 is a perspective view illustrating the raising and lowering member 20. As illustrated in FIG. 4, the raising and lowering member 20 includes (i) two bottom parts 22 to which the raising and lowering rail 30 is provided and (ii) placement parts 23 provided in a manner so as to span across the bottom parts 22 in a direction perpendicular to a direction in which the raising and lowering rail 30 extends. The placement parts 23 have top surfaces 231 provided with through holes (holes) 21. The through holes 21 are parts to be engaged with protrusions 41 of the platform 40 when the platform 40 is installed on the raising and lowering member 20. Note that it is alternatively possible to provide depressions in the top surfaces 231, instead of holes having shapes which, as in the case of the through holes 21, penetrate through the top surfaces 231 of the placement parts 23. The depressions can also be engaged with the protrusions 41.

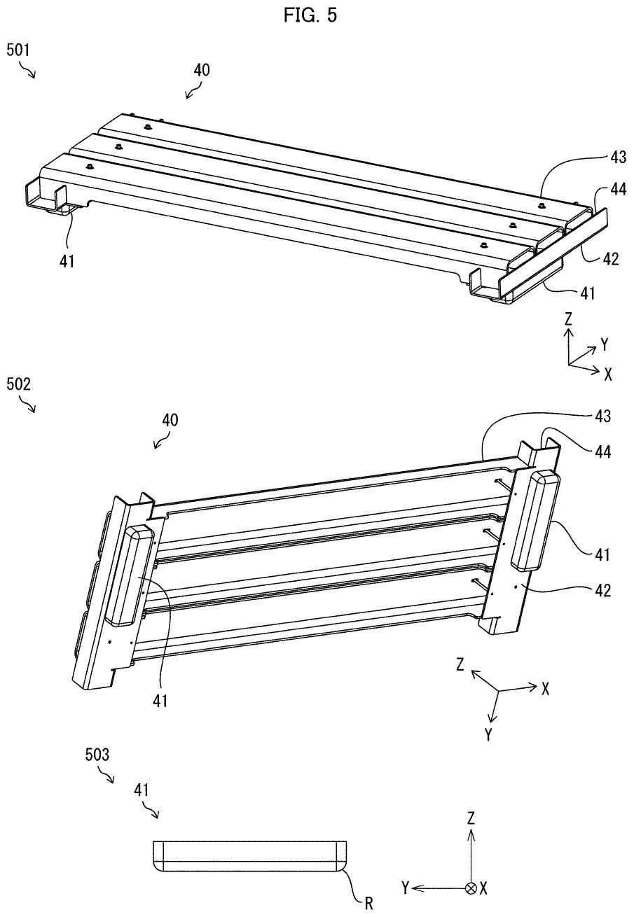

FIG. 5 illustrates an appearance of the platform 40. The reference numeral 501 of FIG. 5 indicates a perspective view illustrating an appearance of the platform 40 as viewed from above. As illustrated in the reference numeral 501 of FIG. 5, the platform 40 has, for example, a shape of a single board formed by arranging, along a shorter dimension of the platform 40 (y direction), a plurality of shelf boards 43 which have substantially rectangular shapes and connecting the shelf boards 43 at end parts 44 positioned at longer-dimension ends (x-direction ends). In the example shown in the reference numeral 501 of FIG. 5, the three shelf boards 43 are arranged along the shorter dimension so as to form the single platform 40. In addition, the end parts 44 have bottom surfaces 42 provided with the protrusions 41.

The reference numeral 502 of FIG. 5 indicates a perspective view illustrating an appearance of the platform 40 as viewed from below. As illustrated in the reference numeral 502 of FIG. 5, the bottom surfaces 42 of the longer-dimension end portions of the platform 40 are provided with the protrusions 41.

The reference numeral 503 of FIG. 5 indicates a view illustrating an example of each of the protrusions 41 provided on a bottom surface of the platform 40. As illustrated in the reference numeral 503 of FIG. 5, the protrusion 41 has round portions R at corners of a bottom portion of the protrusion 41, that is, corners on a side of the protrusion 41 closer to the raising and lowering member 20 on which the platform 40 is placed. The corners of the bottom portion of the protrusion 41 may have, instead of the round portions R, a tapered shape such that an area of the protrusion 41 on a horizontal plane becomes smaller toward a lower portion of the protrusion 41, that is, a tapered shape such that the protrusion 41 becomes thinner toward the tip of the protrusion 41. This makes it easy to engage the protrusions 41 of the platform 40 and the through holes 21 of the raising and lowering member 20 with each other.

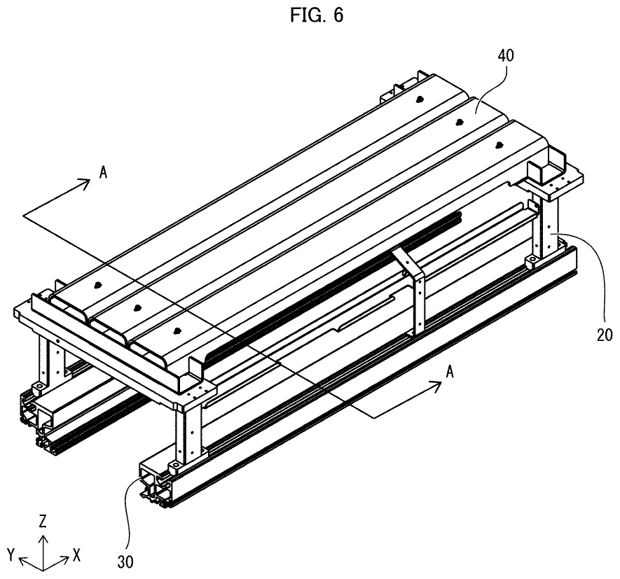

FIG. 6 is a perspective view showing that the platform 40 is placed on the raising and lowering member 20. As illustrated in FIG. 6, the platform 40 is placed on the raising and lowering member 20 such that the end parts 44 of the platform 40 are placed on top surfaces of the placement parts 23 of the raising and lowering member 20. When the platform 40 is placed on the raising and lowering member 20, the protrusions 41 provided to the end parts 44 of the platform 40 and the through holes 21 provided on the top surfaces of the placement parts 23 of the raising and lowering member 20 are engaged with each other. This makes it possible to suppress, during the placement of the platform 40, movement of the platform 40 in a horizontal direction with respect to the raising and lowering member 20. The horizontal direction refers to a direction parallel to the horizontal plane and is, for example, the x direction or the y direction.

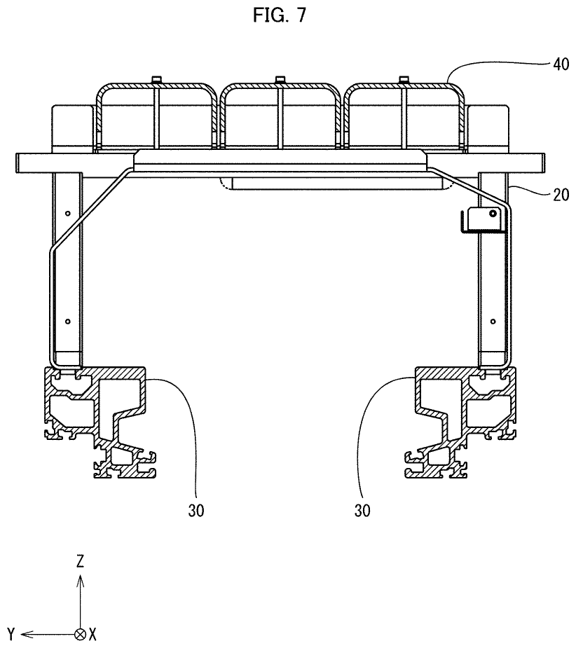

FIG. 7 is a cross-sectional view taken along the A-A line in FIG. 6. As illustrated in FIG. 7, when the platform 40 is placed on the raising and lowering member 20, the protrusions 41 and the through holes 21 are engaged with each other.

As described above, the platform 40 is provided with, on the bottom surfaces 42, the protrusions 41 protruding in a vertical direction, and the raising and lowering member 20 is provided with the through holes 21 on the top surfaces 231. When the platform 40 is placed on the raising and lowering member 20, the protrusions 41 are engaged with the through holes 21. This makes it possible to restrain the platform 40 from moving in the horizontal direction. Note that it is alternatively possible that the top surfaces 231 of the raising and lowering member 20 are provided with protruding parts protruding upward, and the bottom surfaces 42 of the platform 40 are provided with through holes or depressions. This configuration allows the protruding parts and the through holes or the depressions to be engaged with each other and thus also makes it possible to restrain the platform 40 from moving in the horizontal direction with respect to the raising and lowering member 20.

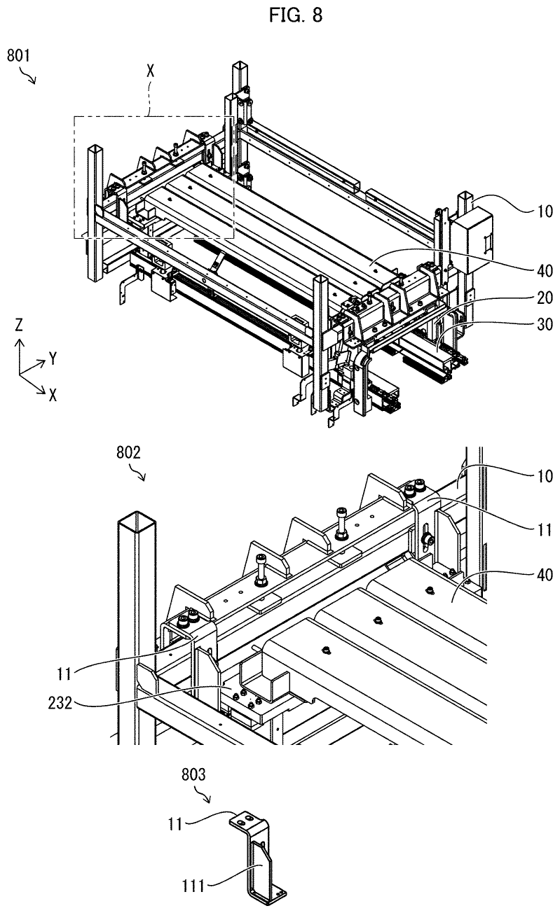

FIG. 8 shows that the raising and lowering member 20 on which the platform 40 is placed is installed in the raising and lowering device 100. The reference numeral 801 of FIG. 8 indicates a view illustrating an example in which the raising and lowering member 20 on which the platform 40 is placed is provided in the raising and lowering device 100. The reference numeral 802 of FIG. 8 indicates an enlarged view of a portion enclosed by the quadrangular frame X in the reference numeral 801.

As illustrated in the reference numeral 802 of FIG. 8, end parts 232 of the placement parts 23 are supported by support parts 11 provided to the frame 10 of the raising and lowering device 100, so that the raising and lowering member 20 is provided in the space defined by the frame 10 of the raising and lowering device 100. For example, the support parts 11 may be provided at four corners of the raising and lowering member 20 on a horizontal plane or may be provided at, as well as the four corners, substantially center portions in a longer dimension (x direction) of the raising and lowering member 20.

The raising and lowering member 20 cannot move to a position below the position at which the support parts 11 are to support the raising and lowering member 20. Thus, the support parts 11 can be said to set a lowering stoppage position at which the lowering of the raising and lowering member 20 stops. In other words, the support parts 11 are provided at the lowering stoppage position of the raising and lowering member 20.

Each of the support parts 11 provided at the four corners may have, for example, a wall surface 111 having an L-shaped horizontal cross section (see the reference numeral 803 of FIG. 8). The L-shaped portion can restrain the end part 232 of the placement part 23 from moving in the horizontal direction and thus allows the raising and lowering member 20 to be stably supported.

Further, in a downward direction (in negative z direction), the wall surface 111 of the support part 11 may incline increasingly toward an inside of the space defined by the frame 10. The inclination of the wall surface 111 toward the inside allows the support part 11 to set a horizontal position of the raising and lowering member 20 as well as to set the lowering stoppage position of the raising and lowering member 20.

As described above, the raising and lowering device 100 in accordance with the present embodiment includes the frame 10, the raising and lowering rail 30 that the conveyance carriage 120 is able to enter, the raising and lowering member 20, and the platform 40. The raising and lowering member 20 is raised and lowered integrally with the raising and lowering rail 30. Further, when located at the lowering stoppage position, the raising and lowering member 20 is supported by the support parts 11 provided to the frame 10. Furthermore, the platform 40 is detachably placed on the raising and lowering member 20. The platform 40 is placed on the raising and lowering member 20 in a state in which the protrusions 41, which are parts of the platform 40, are engaged with the through holes 21, which are parts of the raising and lowering member 20, in a manner so as to restrain the platform 40 from moving in the horizontal direction.

The platform 40 can be installed merely through placement on the raising and lowering member 20. This facilitates the installation of the platform 40. Further, the platform 40 is dividable into small segments and therefore can be easily installed even by an operator S with little strength. Furthermore, the raising and lowering member 20 on which the platform 40 is to be placed is supported by the frame 10. This prevents a load from an operator S on the platform 40 from being applied to the raising and lowering rail 30 and thus can prevent the raising and lowering rail 30 from being deformed and from being damaged.

The platform 40 and the raising and lowering member 20 that are engaged with each other in a manner so as to restrain the platform 40 from moving in the horizontal direction are placed in the frame 10. This can prevent the platform 40 from moving the horizontal direction and thus can improve safety of the platform 40.

### Variation 1 of Platform 40

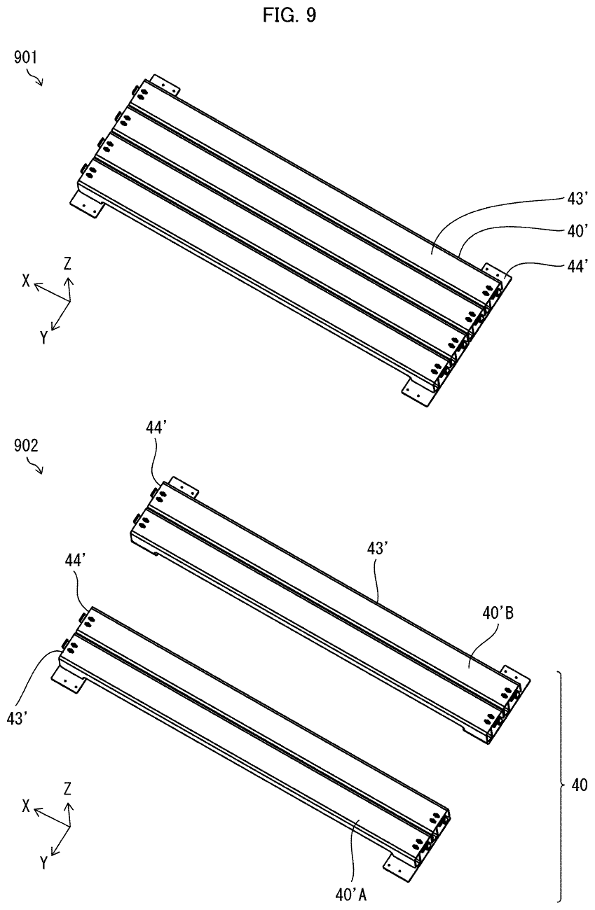

FIG. 9 illustrates a platform 40′ which is a variation of the platform 40. The reference numeral 901 of FIG. 9 indicates a perspective view illustrating the platform 40′. The reference numeral 902 of FIG. 9 indicates a view illustrating a state in which the platform 40′ is divided into a platform 40′A and a platform 40′B. The platform 40′ differs from the platform 40 described above in that the platform 40′ is dividable into two segments, as illustrated in the reference numeral 902.

The platform 40′ has, for example, a shape of a single board formed by arranging, along a shorter dimension of the platform 40′ (y direction), a plurality of shelf boards 43′ which have substantially rectangular shapes and connecting the shelf boards 43′ at end parts 44′ positioned at longer-dimension ends (x-direction ends). In an example shown in the reference numeral 901 of FIG. 9, each of the platform 40′A and the platform 40′B is formed by the two shelf boards 43′ arranged along the shorter dimension, and the platform 40′A and the platform 40′B are combined so as to form the platform 40′. In addition, the end parts 44′ of each of the platform 40′A and the platform 40′B have bottom surfaces 42′ provided with protrusions 41′.

The platform 40′ is dividable into the two platforms 40′A and 40′B, each of which weighs less than the single platform 40′. This makes it possible to reduce a burden on the operator S of placement of the platform 40′.

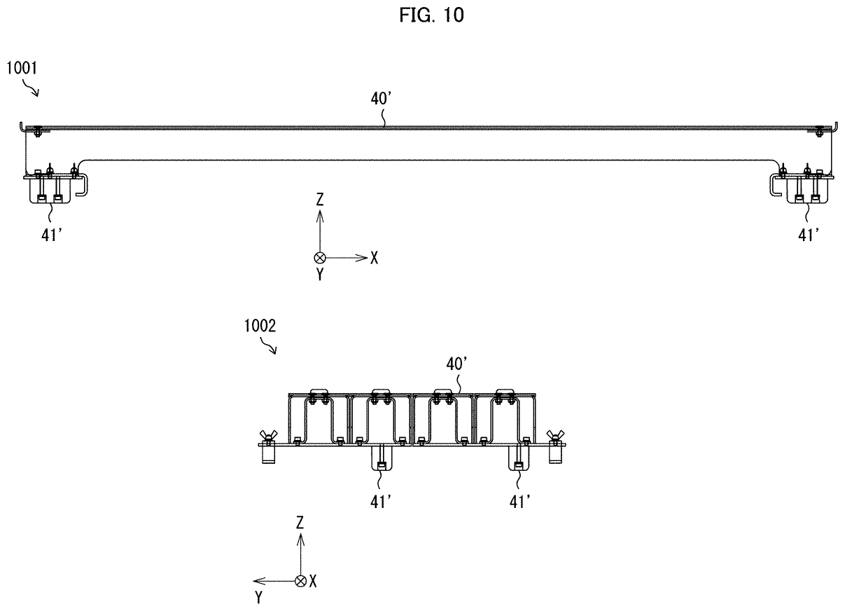

The reference numeral 1001 of FIG. 10 indicates a longer-dimension cross section of the platform 40′, and the reference numeral 1002 of FIG. 10 indicates a shorter-dimension cross section of the platform 40′. The platform 40′A and the platform 40′B have the same longer-dimension cross section. As illustrated in the reference numeral 1001 of FIG. 10, each of the platform 40′A and the platform 40′B has the longer-dimension end parts 44′ which have the bottom surfaces 42′ provided with the protrusions 41′.

In addition, as illustrated in the reference numeral 1002 of FIG. 10, each of the platform 40′A and the platform 40′B is provided with the protrusions 41′.

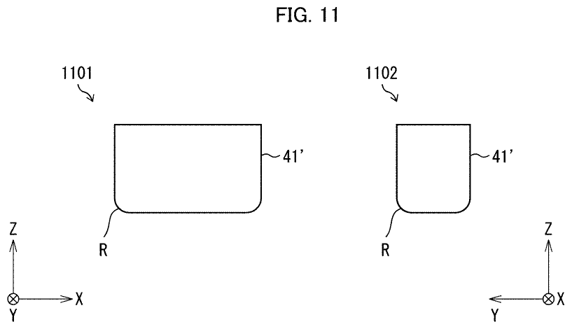

FIG. 11 illustrates an example of each of the protrusions 41′. As illustrated in FIG. 11, the protrusion 41′ is a substantially rectangular shape that is longer in the x direction on the horizontal plane. In addition, round portions R are provided at corners on a bottom portion side of the protrusion 41′.

When the raising and lowering member 20 is provided with through holes corresponding to the protrusions 41′, it is possible to place the platform 40′ on the raising and lowering member 20 with the protrusions 41′ of the platform 40′ engaged with the through holes of the raising and lowering member 20.

### Variation 2 of Platform 40

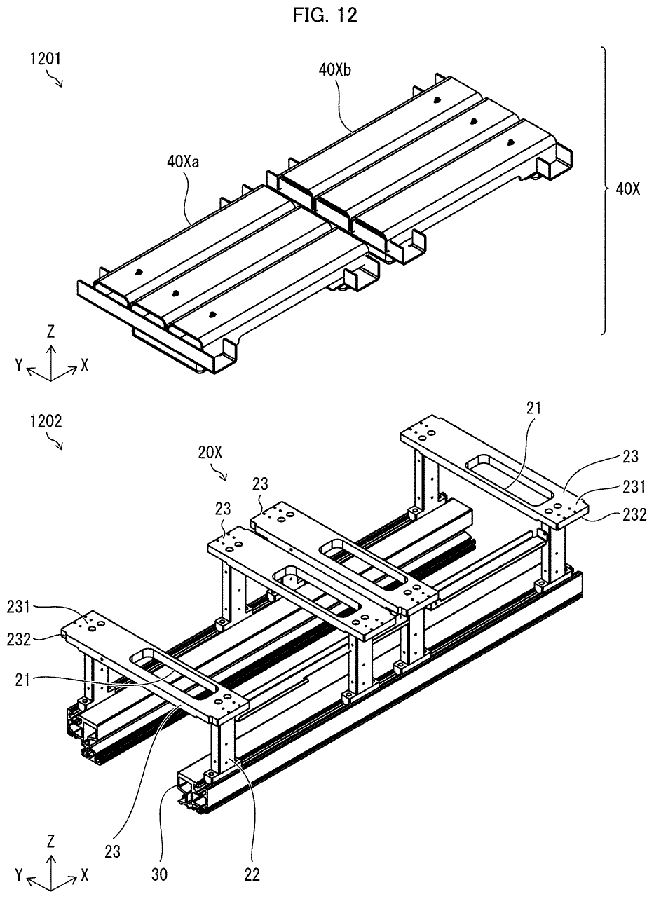

FIG. 12 illustrates a platform 40X which is a variation of the platform 40. The reference numeral 1201 of FIG. 12 indicates a perspective view illustrating the platform 40X. The reference numeral 1202 of FIG. 12 indicates an example of a raising and lowering member 20X on which the platform 40X is to be placed. As illustrated in the reference numeral 1201 of FIG. 12, the platform 40X is divided into a platform 40Xa and a platform 40Xb along a direction (y direction) perpendicular to a direction along the raising and lowering rail 30.

The platform 40X is dividable into the two platforms 40Xa and 40Xb, each of which weighs less than the single platform 40X. This makes it possible to reduce a burden on the operator S of placement of the platform 40X.

In addition, the raising and lowering member 20X is provided with placement parts 23 at a substantial center of the raising and lowering member 20X, as well as at x-direction end portions of the raising and lowering member 20X. The placement parts 23 are also provided at the substantial center of the raising and lowering member 20X in the x direction, so that the placement parts 23 are provided under the substantial center of the platform 40X in the x direction, in other words, under x-direction end parts of the platform 40Xa and the platform 40Xb. This makes it possible to stably place the platform 40X.

In the conventional art, a platform is provided over frames in a manner so as to span across the frames, and thus dividing the platform along a direction perpendicular to a direction along a rail, that is, dividing the platform along a dividing line perpendicular to the rail, precludes the platform from being supported. Therefore, in the conventional art, it is unimaginable in the first place that the platform is divided along the direction perpendicular to the rail. In the present embodiment, the platform 40 is placed on the raising and lowering member 20 rather than on the frame 10, as described above. Therefore, providing the placement parts 23 to the raising and lowering member 20 allows the platform 40X to be divided, along the direction (y direction) perpendicular to the direction along the raising and lowering rail 30, into the platform 40Xa and the platform 40Xb.

### Restraint Part

A restraint part may be provided which, only when the platform 40 is placed on the raising and lowering member 20, restrains the raising and lowering member 20 from being raised and lowered. The platform 40 is used for the maintenance of the raising and lowering device 100. Thus, it is highly likely that the platform 40 is placed during, immediately before, or immediately after the maintenance of the raising and lowering device 100. Therefore, when the platform 40 is placed, activation of the raising and lowering device 100, that is, raising and lowering of the raising and lowering member 20 is dangerous. Therefore, it is possible to include a restraint part which, when the platform 40 is placed on the raising and lowering member 20, restrains the raising and lowering member 20 from being raised and lowered and which has no impact on the raising and lowering of the raising and lowering member 20 when the platform 40 is not placed on the raising and lowering member 20.

The restraint part can be achieved in any form or manner, provided that the restraint part restrains raising and lowering of the raising and lowering member 20 in response to placement of the platform 40 and has no impact on the raising and lowering of the raising and lowering member 20 when the platform 40 is detached. For example, the restraint part can be a structure which locks the raising and lowering member 20 and the frame 10 in response to the placement of the platform 40.

Aspects of the present invention can also be expressed as follows:
A raising and lowering device in accordance with Aspect 1 of the present invention includes: a frame; a rail that a ceiling traveling vehicle is able to enter and that is able to be raised and lowered; a raising and lowering part configured to be raised and lowered integrally with the rail and to be, when located at a lowering stoppage position, supported by a support part provided to the frame; and a platform configured to be detachably placed on the raising and lowering part. The platform is configured to be placed on the raising and lowering part in a state in which a part of the platform is engaged with a part of the raising and lowering part in a manner so as to restrain the platform from moving in a horizontal direction.

According to the above configuration, it is possible to install the platform merely through placement on the raising and lowering member. This facilitates the installation of the platform. Further, the platform is dividable into small segments and thus can be easily installed by an operator with little strength. Furthermore, the raising and lowering member on which the platform is to be placed is supported by the frame. This prevents a load from the operator on the platform from being applied to the rail and thus can prevent the rail from being deformed and from being damaged.

In addition, the platform and the raising and lowering member that are engaged with each other in a manner so as to restrain the platform from moving in the horizontal direction are placed in the frame. This can prevent the platform from moving in the horizontal direction. This improves safety of the platform.

A raising and lowering device in accordance with Aspect 2 of the present invention is configured, in Aspect 1, such that: the platform is provided with, on a bottom surface of the platform, a protruding part protruding in a vertical direction; the raising and lowering part is provided with a hole at a top surface of the raising and lowering device; and the protruding part is engaged with the hole when the platform is placed on the raising and lowering part.

According to the above configuration, the protruding part of the platform and the hole of the raising and lowering part are engaged with each other, so that it is possible to restrain the platform from moving in the horizontal direction.

A raising and lowering device in accordance with Aspect 3 of the present invention is configured, in Aspect 1 or 2, such that a tip of the protruding part is shaped such that an area of a horizontal cross section of the tip becomes smaller at a position closer to the raising and lowering part.

The above configuration makes it easy to engage the protruding part of the platform and the hole of the raising and lowering part with each other.

A raising and lowering device in accordance with Aspect 4 of the present invention is configured, in any one of Aspects 1 to 3, such that the support part has a wall surface having an L-shaped horizontal cross section.

According to the above configuration, it is possible to suppress shift of the raising and lowering part in the horizontal direction when the raising and lowering part is located at the lowering stoppage position.

A raising and lowering device in accordance with Aspect 5 of the present invention is configured, in Aspect 4, such that, in a downward direction, the wall surface inclines increasingly toward an inside of a space defined by the frame.

According to the above configuration, the inclination of the wall surface makes it possible to support the raising and lowering part at a predetermined position, and thus it is possible to appropriately set a horizontal position of the raising and lowering part.

A raising and lowering device in accordance with Aspect 6 of the present invention is configured, in Aspect 4 or 5, such that the support part is provided at the lowering stoppage position of the raising and lowering part.

According to the above configuration, it is possible to appropriately set the lowering stoppage position of the raising and lowering part.

A raising and lowering device in accordance with Aspect 7 of the present invention is configured, in any one of Aspects 1 to 6, to further include a restraint part that, only when the platform is placed on the raising and lowering part, restrains the raising and lowering part from being raised and lowered.

According to the above configuration, it is possible to prevent the raising and lowering part from being raised and lowered when the platform is placed.

A raising and lowering device in accordance with Aspect 8 of the present invention is configured, in any one of Aspects 1 to 7, such that the platform is dividable, along a direction in which the rail extends, into a plurality of segments.

According to the above configuration, the platform is dividable into a plurality of segments, and thus it is possible to easily place the platform, compared with the case where the platform is provided in an undividable form.

A raising and lowering device in accordance with Aspect 9 of the present invention is configured, in any one of Aspects 1 to 7, such that the platform is dividable, along a direction perpendicular to a direction in which the rail extends, into a plurality of segments.

According to the above configuration, the platform is dividable into a plurality of segments, and thus it is possible to easily place the platform, compared with the case where the platform is provided in an undividable form.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1 Conveyance carriage system
10 Frame
11 Support part
111 Wall surface
20, 20X Raising and lowering member (raising and lowering part)
21 Through hole (hole)
22 Bottom part
23 Placement part
231 Top surface
232 End part
30 Raising and lowering rail (rail)
40, 40′, 40X Platform
41, 41′ Protrusion (protruding part)
42, 42′ Bottom surface
43, 43′ Shelf board
44, 44′ End part
100 Raising and lowering device
110, 110A, 110B Traveling rail
120 Conveyance carriage

1. A raising and lowering device comprising:
a frame;
a rail that a ceiling traveling vehicle is able to enter and that is able to be raised and lowered;
a raising and lowering part configured to be raised and lowered integrally with the rail and to be, when located at a lowering stoppage position, supported by a support part provided to the frame; and
a platform configured to be detachably placed on the raising and lowering part,
the platform being configured to be placed on the raising and lowering part in a state in which a part of the platform is engaged with a part of the raising and lowering part in a manner so as to restrain the platform from moving in a horizontal direction.

2. The raising and lowering device according to claim 1, wherein:
the platform is provided with, on a bottom surface of the platform, a protruding part protruding in a vertical direction;
the raising and lowering part is provided with a hole at a top surface of the raising and lowering device; and
the protruding part is engaged with the hole when the platform is placed on the raising and lowering part.

3. The raising and lowering device according to claim 2, wherein a tip of the protruding part is shaped such that an area of a horizontal cross section of the tip becomes smaller at a position closer to the raising and lowering part.

4. The raising and lowering device according to claim 1, wherein the support part has a wall surface having an L-shaped horizontal cross section.

5. The raising and lowering device according to claim 4, wherein, in a downward direction, the wall surface inclines increasingly toward an inside of a space defined by the frame.

6. The raising and lowering device according to claim 4, wherein the support part is provided at the lowering stoppage position of the raising and lowering part.

7. The raising and lowering device according to claim 1, further comprising a restraint part that, only when the platform is placed on the raising and lowering part, restrains the raising and lowering part from being raised and lowered.

8. The raising and lowering device according to claim 1, wherein the platform is dividable, along a direction in which the rail extends, into a plurality of segments.

9. The raising and lowering device according to claim 1, wherein the platform is dividable, along a direction perpendicular to a direction in which the rail extends, into a plurality of segments.
